(19) United States
(12) Patent Application Publication
(10) Pub. No.: US 2020/0365172 A1
(43) Pub. Date: Nov. 19, 2020

(54) STORAGE MEDIUM, CONTROL DEVICE, AND CONTROL METHOD

(71) Applicant: FUJITSU LIMITED, Kawasaki-shi (JP)

(72) Inventors: Akihiro Takahashi, Kawasaki (JP); MASAKI MIURA, Kawasaki (JP); Yohei YAMAGUCHI, Kawasaki (JP); Masao Nishijima, Kawasaki (JP); SHINGO TOKUNAGA, Kawasaki (JP)

(73) Assignee: FUJITSU LIMITED, Kawasaki-shi (JP)

(21) Appl. No.: 15/931,676

(22) Filed: May 14, 2020

(30) Foreign Application Priority Data
May 16, 2019 (JP) 2019-092541

(51) Int. Cl. G10L 25/78; G10L 25/51; G06F 3/16; H04L 12/18; H04L 29/06

(52) U.S. Cl. CPC G10L 25/78; G10L 25/51; G06F 3/16; G10L 2025/783; H04L 12/1895; H04L 65/1066; H04L 65/403; H04L 12/1822

(57) ABSTRACT

A method includes calculating an activity level of participant in a conference; determining whether to cause a voice output device to perform a speech operation to speak to one of the participants, based on a first level of the entire conference during a first period until a time that is earlier than a current time by a first time, the first level being calculated based on the respective activity levels; and when having determined to cause the voice output device to perform the speech operation, determining a person in the speech operation from among the participants, based on a second level of the entire conference during a second period until a time that is earlier than the current time by a second time longer than the first time, and the respective activity levels of the participants, the second level being calculated based on the respective activity levels of the participants.

### CROSS-REFERENCE TO RELATED APPLICATION

This application is based upon and claims the benefit of priority of the prior Japanese Patent Application No. 2019-92541, filed on May 16, 2019, the entire contents of which are incorporated herein by reference.

### FIELD

The embodiments discussed herein are related to a control program, a control device, and a control method.

### BACKGROUND

In recent years, research and development of technology for interacting with humans has been promoted. Use such technology in conferences is also being considered.

As a suggested example of an interactive technique that can be used in a conference, an interactive device estimates the current emotion of a user with a camera, a microphone, a biological sensor, and the like, extracts from a database a topic that may change the current emotion to a desired emotion, and interacts with the user on the extracted topic.

A technique for objectively evaluating the quality of a conference has also been suggested. For example, there is a suggested conference support system that calculates a final quality value of a conference, on the basis of opinions from participants in the conference and results of evaluation of various evaluation items calculated from physical quantities acquired during the conference. Japanese Laid-open Patent Publication No. 2018-45118, Japanese Laid-open Patent Publication No. 2010-55307, and the like, are disclosed as related art, for example.

### SUMMARY

According to an aspect of the embodiments, a control method executed by a computer, the control method comprising: calculating an activity level for each of a plurality of participants in a conference; determining whether to cause a voice output device to perform a speech operation to speak to one of the participants, on the basis of a first activity level of the entire conference during a first period until a time that is earlier than a current time by a first time, the first activity level being calculated on the basis of the respective activity levels of the participants; and when having determined to cause the voice output device to perform the speech operation, determining a person to be spoken to in the speech operation from among the participants, on the basis of a second activity level of the entire conference during a second period until a time that is earlier than the current time by a second time longer than the first time, and the respective activity levels of the participants, the second activity level being calculated on the bass of the respective activity levels of the participants

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example configuration of a conference support system and an example process according to a first embodiment;

FIG. 2 is a diagram illustrating an example configuration of a conference support system according to a second embodiment;

FIG. 3 is a diagram illustrating example hardware configurations of a robot and a server device;

FIG. 4 is a first example illustrating transitionof the activity level of a conference;

FIG. 5 is a second example illustrating transition of he activity level of a conference;

FIG. 6 is a diagram for explaining a method of calculating the activity level of each participant;

FIG. 7 is a block diagram illustrating an example configuration of the processing functions of a server device;

FIG. 8 is a diagram illustrating an example data structureof an evaluation value table;

FIG. 9 is an example of a flowchart (part 1) illustrating processes to be performed by the server device;

FIG. 10 is an example of a flowchart (part 2) illustrating processes to be performed by the server device; and

FIG, 11 is an example of a flowchart (part 3) illustrating processes to be performed by the server device.

### DESCRIPTION OF EMI OD MENTS

A conference moderator is expected to have the ability to enhance the quality of a conference. For example, the moderator activates discussions by selecting an appropriate participant at an appropriate timing and prompting the participant to speak. Further, there are interactive techniques suggested for supporting the role of such moderators. However, with any of the existing interactive techniques, it is difficult to correctly determine the timing to prompt a speech and the person to be spoken to, in accordance with the state of the conference. In view of the above, it is desirable to make a conference active.

Hereinafter, embodiments will be described with reference to the accompanying drawings.

### First Embodiment

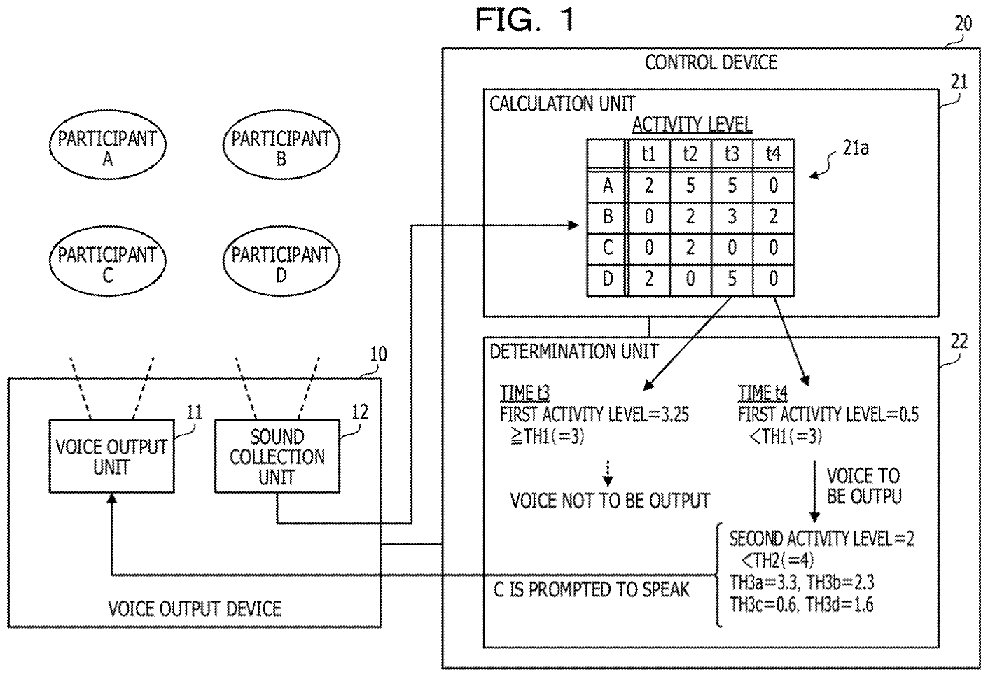

FIG. 1 is a diagram illustrating an example configuration of a conference support system and an example process according to a first embodiment. The conference support system illustrated in FIG. 1 includes a voice output device 10 and a control device 20.

The voice output device 10 includes a voice output unit 11 that outputs voice to conference participants. In the example illustrated in FIG. 1, four participants A through D participate in the conference, and the voice output device 10 is installed so that voice from the voice output unit 11 reaches the participants A through D. A voice output operation by the voice output unit 11 is controlled by the control device 20.

Also, in the example illustrated in FIG. 1, the voice output device 10 further includes a sound collection unit 12 that collects voices emitted from the participants A through D. The voice information collected by the sound collection unit 12 is transmitted to the control device 20.

The control device 20 is a device that supports the progress of a conference by controlling the voice output operation being performed by the voice output unit 11 of the voice output device 10. The control device 20 includes a calculation unit 21 and a determination unit 22. The processes by the calculation unit 21 and the determination unit 22 are realized by a processor (not illustrated) included in the control device 20 executing a predetermined program, for example.

The calculation unit 21 calculates activity levels of the respective participants A through D in the conference. The activity levels indicate the activity levels of the participants' actions and emotions in the conference. In the example illustrated in FIG. 1, activity levels are calculated at least on the basis of the voice information about the participants A through D collected by the sound collection unit 12. In this case, the activity level of a participant becomes higher, as the speech time of the participant becomes longer, the participants voice becomes louder, or the emotion based on the participants voice becomes more positive, for example. Further, in another example, activity levels may be calculated on the bass of the participants' facial expressions.

A table 21a in FIG. 1 records an example of activity levels of the respective participants A through a as calculated by the calculation unit 21. Times ti through t4 indicate time zones (periods) of the same length, and activity levels are calculated in each of those time zones. Hereinafter, the respective time zones corresponding to times U. through t4 will be referred to as the “unit time zones”. Further, the activity levels are represented by values from 0 to 10, for example.

The determination unit 22 controls the operation for causing the voice output unit 11 to output a voice to make the conference more active, on the basis of the activity levels calculated by the calculation unit 21. This voice output operation is a speech operation in which one of the participants A through is designated, and a speech is directed to the designated participant. An example of this speech operation may be an operation for outputting a voice that prompts the designated participant to speak. The determination unit 22 determines the timing to cause the voice output unit 11 to perform the speech operation described above, and the person to be spoken to in the speech operation, on the basis of a first activity level and a second activity level calculated from the activity levels of the respective participants A through D. Note that the first activity level and the second activity level may be calculated by the calculation unit 21, or may be calculated by the determination unit 22.

The first activity level indicates the activity level of the entire conference during a first period until the time that is earlier than the current time by a first time. The second activity level indicates the activity level of the entire conference during a second period until the time that is earlier than the current time by a second time that is longer than the first time. Accordingly, the first activity level indicates a short-term activity level of the conference, and the second activity level indicates a longer-term activity level.

In the example illustrated in FIG. 1, the first time is a time equivalent to one unit time zone. In this case, the first activity level at a certain time is calculated on the basis of the respective activity levels of the participants A through D in the unit time zone corresponding to the time. For example, the first period corresponding to time t3 is the unit time zone corresponding to time t3, and the first activity level at time t3 is calculated on the basis of the respective activity levels of the participants A through D in the unit time zone corresponding to time t3. Further, an example of the first activity level is calculated by dividing the total value of the respective activity levels of the participants A through D in the corresponding time zone by the number of the participants A through D.

Also, in the example illustrated in FIG. 1, the second time is a time equivalent to three unit time zones. In this case, the second period corresponding to time t3 is the time zone from time t1 to time t3, for example, and the second activity level at time t3 is calculated on the basis of the respective activity levels of the participants A through D in the time zone from time t1 to time t3. Further, an example of the second activity level is calculated by dividing the total value of the respective activity levels of the participants A through D in the corresponding time zone by the number of the unit time zones and the number of the participants A through D.

The determination unit 22 determines whether to cause the voice output unit 11 to perform the speech operation described above, based on the first activity level. In other words, the determination unit 22 determines the timing to cause the voice output unit 11 to perform the speech operation. In a case where it is determined to cause the voice output unit 11 to perform the speech operation, the determination unit 22 determines the person to be spoken to from among the participants A through D, on the basis of the second activity level and the respective activity levels of the participants A through D. Thus, the conference can be made active.

For example, in a case where the first activity level is lower than a predetermined threshold TH1, it is determined that the activity level of the conference has dropped. Example cases where the activity level of the conference is low include a case where few speeches are made, and discussions are not active, a case where the overall facial expression of the participants A through D is dark, and there is no excitement in the conference, and the like. In such cases, it is considered that the conference can be made active by prompting one of the participants A through D to speak. Therefore, in a case where the first activity level is lower than the threshold TH1, the determination unit 22 determines to cause the voice output unit 11 to perform the speech operation to speak to one of the participants A through D. As one of the participants A through D is spoken to, the person to be spoken to is likely to speak. Thus, the speech operation can prompt the person to be spoken to to speak.

In FIG. 1, the threshold TH1=3, for example. Also, in the example illustrated in FIG. 1, the first activity level at time t3 is (5+3+0+5)/4=3.25, which is not lower than the threshold TH1. Therefore, the determination unit 22 determines not to cause the voice output unit 11 to perform the speech operation. Meanwhile, the first activity level at time t4 is (0+2+0+0)/4=0.5, which is lower than the threshold TH1. Therefore, the determination unit 22 determines to cause the voice output unit 11 to perform the speech operation,

Here, the first activity level indicates a short-term activity level of the conference, and the second activity level indicates a longer-term activity level, as described above. Further, in a case where the second activity level is lower than a predetermined threshold TH2, for example, the long-term activity level of the conference is estimated to be low. Conversely, in a case where the second activity level is equal to or higher than the threshold TH2, the long-term activity level of the conference is estimated to be high.

For example, in a case where the first activity level is lower than the threshold TH1 but the second activity level is equal to or higher than the threshold TH2, the short-term activity level of the conference is estimated to be low, but the long-term activity level of the conference is estimated to be high. In this case, it is estimated that the decrease in the activity level is temporary, and the activity level of the entire conference has not dropped. In such a case, a participant with a relatively low activity level can be made to speak, to cancel the temporary decrease in the activity level, for example. Also, the activity levels of all the participants can be made uniform, and the uniformization can increase the quality of the conference, Therefore, in a case where the first activity level is lower than the threshold TH1, and the second activity level is equal to or higher than the threshold TH2, the determination unit 22 determines the participant with the lowest activity level among the participants A through D to be the person to be spoken to.

On the other hand, in a case where the first activity level is lower than the threshold TH1, and the second activity level is lower than the threshold TH2, for example, both the short-term activity level and the long-term activity level of the conference are estimated to be low. In this case, the decrease in the activity level of the conference is not temporary but is a long-term decline, and the activity level of the entire conference is estimated to be low. In such a case, a participant with relatively high activity level can be made to speak, for example, to facilitate the progress of the conference, and enhance the activity level of the entire conference. Therefore, in a case where the first activity level is lower than the threshold. TH1, and the second activity level is lower than the threshold TH2, the determination unit 22 determines the participant with the highest activity level among the participants A through D to be the person to be spoken to.

In FIG. 1, the threshold TH2 =4, for example. Further, in the example illustrated in FIG, 1, the second activity level at time t4 is {(5+5+0)/3+(2+3+2)/3+(2+0+0)/3+(0+5+0)/3}/4=2, which is lower than the threshold TH2. Therefore, the determination unit 22 determines the participant with the highest activity level among the participants A through D to be the person to be spoken to.

Here, the long-term activity levels of the participants A through D are compared with one another, for example. The long-term activity level TH3a of the participant A is calculated as (5+5+0)/3=3.3. The long-term activity level TH3b of the participant B is calculated as (2+3+2)/3=2.3. The long-term activity level TH3c of the participant C is calculated as (2+0+0)/3=0.6. The long-term activity level TH3d of the participant. D is calculated as (0+5+0)/3=1.6. Therefore, the determination unit 22 determines the participant. A to be the person to be spoken to, and causes the voice output unit 11 to perform the speech operation with the participant. A as the person to be spoken to.

As described above, the control device 20 can correctly determine the timing to cause the voice output unit 11 to perform the speech operation, and the person to be spoken to in the speech operation, in accordance with the activity level of the conference and the respective activity levels of the participants A through D. Thus, the conference can be made active.

### Second Embodiment

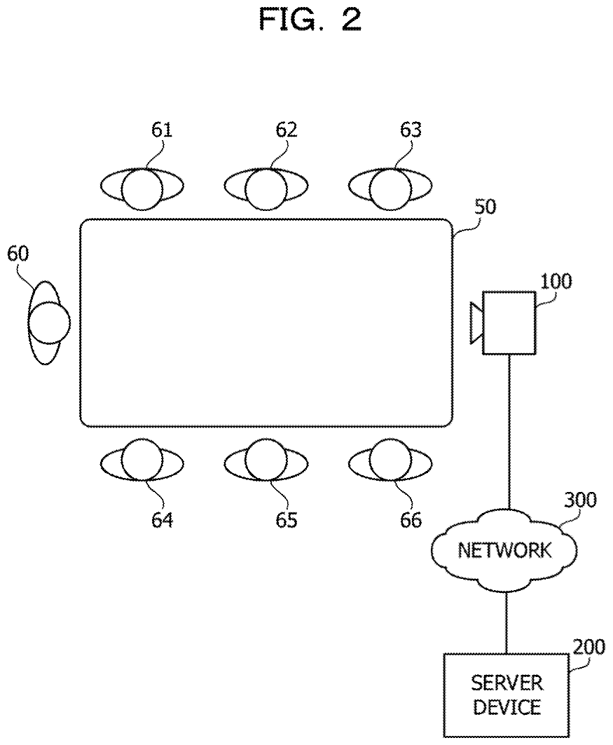

FIG. 2 is a diagram illustrating an example configuration of a conference support system according to a second embodiment. The conference support system illustrated in FIG. 2 includes a robot 100 and a server device 200. The robot 100 and the server device 200 are connected via a network 300. Note that the robot 100 is an example of the voice output device 10 in FIG. 1, and the server device 200 is an example of the control device 20 in FIG. 1.

The robot 100 has a voice output function, is disposed at the side of a conference, and performs a speech operation to support the progress of the conference. In the example illustrated in FIG. 2, the conference is held with a conference moderator 60 and participants 61 through 66 sitting around a conference table 50, and the robot 100 is set near the conference table 50. With such arrangement, the robot 100 can speak as if it were a moderator or a participant, and the strangeness that the conference moderator 60 and the participants 61 through 66 feel when the robot 100 speaks is reduced, so that a natural speech operation can be performed.

The robot 100 also includes sensors for recognizing the state of each participant in the conference. As described later, the robot 100 includes a microphone and a camera as such sensors. The robot 100 transmits the results of detection performed by the sensors to the server device 200, and performs a speed operation according to an instruction from the server device 200.

The server device 200 is a device that controls the speech operation being performed by the robot 100. The server device 200 receives information detected by the sensor of the robot 100, recognizes the state of the conference and the state of each participant on the basis of the detected information, and causes the robot 100 to perform the speech operation according to the recognition results.

For example, the server device 200 can recognize the participants 61 through 66 in the conference from information about sound collected by the microphone and information about an image captured by the camera. The server device 200 can also identify the participant who has spoken among the participants 61 through 66, from voice data obtained through sound collection and voice pattern data about each participant.

The server device 200 further calculates the respective activity levels of the participants 61 through 66, from the respective speech states of the participants 61 through 66, and results of recognition of the respective emotions of the participants 61 through 66 based on the collected voice information and/or the captured image information. On the basis of the respective activity levels of the participants 61 through 66, and the activity level of the entire conference based on those activity levels, the server device 200 causes the robot 100 to perform such a speech operation as to make the conference active and enhance the quality of the conference. In this manner, the progress of the conference is supported.

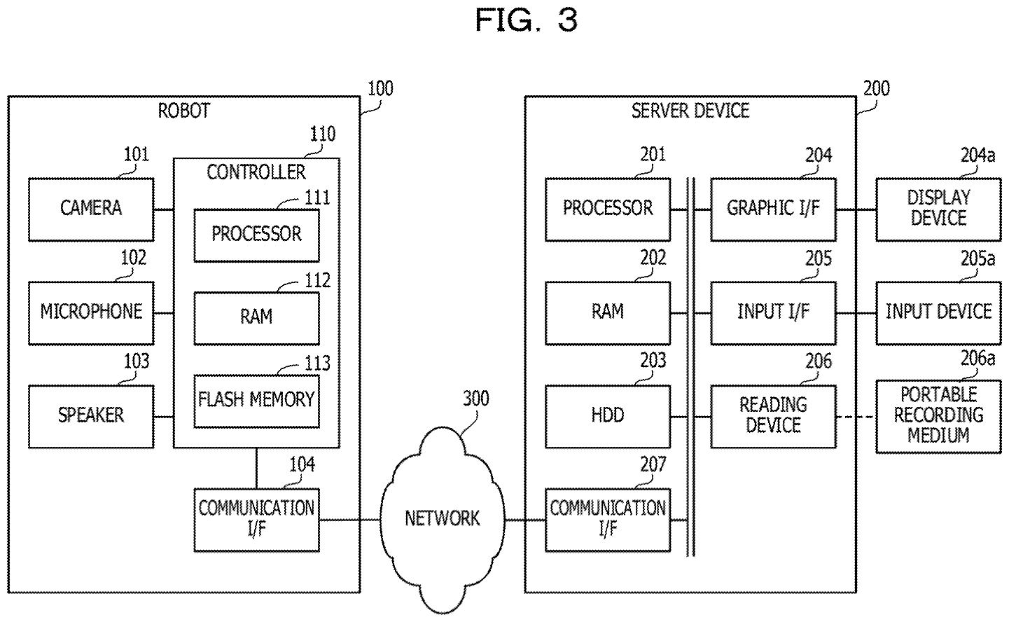

FIG. 3 is a diagram rating example hardware configurations of the robot and the server device.

First, the robot 100 includes a camera 101, a microphone 102, a speaker 103, a communication interface (I/F) 104, and a controller 110.

The camera 101 captures images of the participants in the conference, and outputs the obtained image data to the controller 110. The microphone 102 collects the voices of the participants in the conference, and outputs the obtained voice data to the controller 110. Although one camera 101 and one microphone 102 are installed in this embodiment, more than one camera 101 and more than one microphone 102 may be installed. The speaker 103 outputs a voice based on voice data input from the controller 110. The communication interface 104 is an interface circuit for the controller 110 to communicate with another device such as the server device 200 in the network 300.

The controller 110 includes a processor 111, a random access memory (RAM) 112, and a flash memory 113. The processor 111 comprehensively controls the entire robot 100. The processor 111 transmits image data from the camera 101 and voice data from the microphone 102 to the server device 200 via the communication interface 104, for example. The processor 111 also outputs voice data to the speaker 103 to cause the speaker 103 to output voice, on the basis of instruction information about a speech operation and voice data received from the server device 200. The RAM 112 temporarily stores at least one of the programs to be executed by the processor 111. The flash memory 113 stores the programs to be executed by the processor 111 and various kinds of data.

Meanwhile, the server device 200 includes a processor 201, a RAM 202, a hard disk drive (HDD) 203, a graphic interface (I/F) 204, an input interface (I/F) 205, a reading device 206, and a communication interlace (I/F) 207.

The processor 201 comprehensively controls the entire server device 200. The processor 201 is a central processing unit (CPU), a micro processing unit (MPU), a digital signal processor (CSP), an application specific integrated circuit (ASIC), or a programmable logic device (PLD), for example. Alternatively, the processor 201 may be a combination of two or more processing units among a CPU, an MPU, a DSP, an ASIC, and a PLD.

The RAM 202 is used as a main storage of the server device 200. The RAM 202 temporarily stores at least one of the operating system (OS) program and the application programs to be executed by the processor 201. The RAM 202 also stores various kinds of data desirable for processes to be performed by the processor 201.

The HDD 203 is used as an auxiliary storage of the server device 200. The HDD 203 stores the OS program, application programs, and various kinds of data. Note that a nonvolatile storage device of some other kinds, such as a solid-state drive (SSD), may be used as the auxiliary storage.

A display device 204a is connected to the graphic interface 204. The graphic interface 204 causes the display device 204a to display an image, in accordance with an instruction from the processor 201. Examples of the display device 204a include a liquid crystal display, an organic electroluminescence (EL) display, and the like.

An input device 205a is connected to the input interface 205. The input interface 205 transmits a signal output from the input device 205a to the processor 201. Examples of the input device 205a include a keyboard, a pointing device, and the like. Examples of the pointing device include a mouse, a touch panel, a tablet, a touch pad, a trackball, and the like.

A portable recording medium 206a is attached to and detached from the reading device 206. The reading device 206 reads data recorded on the portable recording medium 206a, and transmits the data to the processor 201. Examples of the portable recording medium 206a include an optical disc, a magneto-optical disc, a semiconductor memory, and the like.

The communication interface 207 transmits and receives data to and from another device such as the robot 100 via the network 300.

With the hardware configuration as described above, the processing function of the server device 200 can be achieved.

Meanwhile, the principal role of a conference moderator is to smoothly lead a conference, but how to proceed with a conference affects the depth of discussions, and changes the quality of discussions. Particularly, in brainstorming, which is a type of conference, it is important for the moderator, called the facilitator, to prompt the participants to speak actively and thus, activate discussions. For this reason, the quality of discussions tends to fluctuate widely depending on the moderator's ability. For example, the quality of discussions might change, if the facilitator becomes enthusiastic about the discussion and is not able to elicit opinions from the participants, or if the facilitator asks only a specific participant to speak, placing disproportionate weight on the participant's opinions.

Against such a background, the role of moderators are expected to be supported with interactive techniques so that the quality of discussions can be maintained above a certain level, regardless of individual differences between moderators. To fulfill this purpose, it is desirable to correctly recognize the situation of each participant and the situation of the entire conference, and perform an appropriate speech operation in accordance with the results of the recognition. For example, an appropriate participant is selected at an appropriate timing in accordance with the results of such situation recognition, and the selected participant is prompted to speak, so that discussions can be activated. In this case, a method of prompting participants who have made few remarks to speak so that each participant speaks equally may be adopted, for example, However, such a method is not always effective depending on situations, and there are times when it is better to prompt a participant who has made many remarks to speak more and let such a participant lead discussions.

A pull-type interactive technique by which questions are accepted and answered has been widely developed as one of the existing interactive techniques. However, a push-type interactive technique by which questions are not accepted, but the current speech situation is assessed, and an appropriate person is spoken to at an appropriate timing is technologically more difficult than the pull-type interactive technique, and has not been developed as actively as the pull-type interactive technique, To realize an appropriate speech operation as described above in supporting a conference, a push-type interactive technique is desirable, but a push-type interactive technique that can fulfill this purpose has not been developed yet.

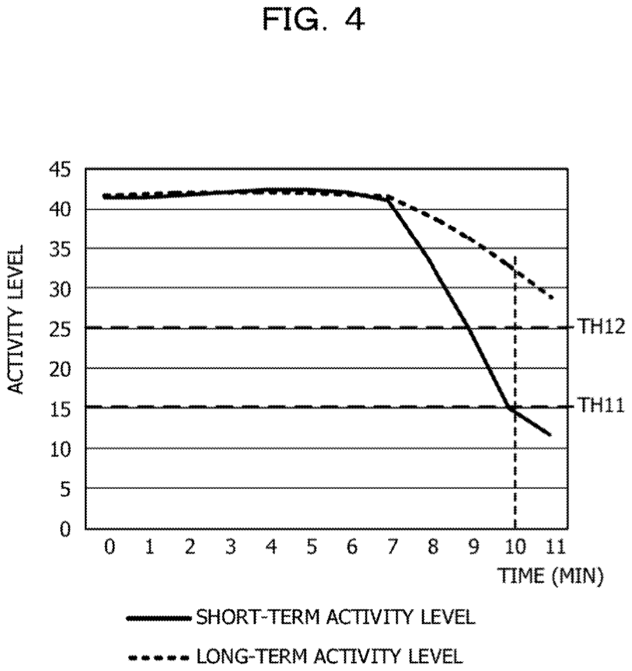

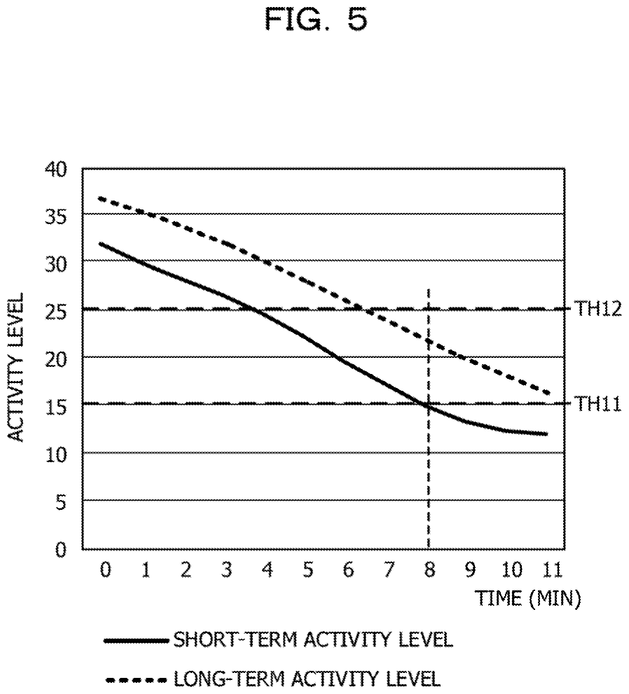

To counter such a problem, the server device 200 of this embodiment activates discussions and enhances the quality of the conference by performing the processes to be described next with reference to FIGS. 4 and 5.

FIG. 4 is a first example illustrating transition of the activity level of a conference. In addition, FIG. 5 is a second example illustrating transition of the activity level of a conference.

In each of FIGS. 4 and 5, a short-term activity level indicates the activity level during the period until the time that is earlier than a certain time by the first time, and a long-term activity level indicates the activity level during the period until the time that is earlier than the certain time by the second time, which is longer than the first time. For example, the short-term activity level indicates the activity level during the last one minute, and the long-term activity level indicates the activity level during the last ten minutes. Further, a threshold TH11 is the threshold for the short-term activity level, and a threshold TH12 is the threshold for the long-term activity level.

When the short-term activity level of the conference falls below the threshold TH11, the server device 200 determines to cause the robot 100 to perform a speech operation to prompt one of the participants to speak to activate the discussion. In the example illustrated in FIG. 4, the short-term activity level falls below the threshold TH11 at the 10-minutes point. Therefore, the server device 200 determines to cause the robot 100 to perform a speech operation at this point of time. In the example illustrated in FIG. 5, on the other hand, the short-term activity level falls below the threshold TH11 at the 8-minute point. Therefore, the server device 200 determines to cause the robot 100 to perform a speech operation at this point of time.

Further, in the example illustrated in FIG. 4, when the short-term activity level of the conference falls below the threshold TH11, the value of the long-term activity level of the conference becomes equal to or higher than the threshold TH12. In other words, at this point of time, the short-term activity level of the conference is low, but the long-term activity level is not particularly low. In this case, it is estimated that the decrease in the activity level at this point of time is temporary, and the activity level of the entire conference has not dropped. For example, this case may be a case where the conversation among the respective participants has temporarily stopped, and the like.

In such a case, the server device 200 determines the participant having a low activity level to be the person to be spoken to in the speech operation, and prompts the participant to speak. Thus, the activity levels among the participants are made uniform, and as a result, the quality of the discussion can be increased. In other words, it is possible to change the contents of the discussion to better contents, by prompting the participants who have made few remarks or the participants who have not been enthusiastic about the discussion to participate in the discussion.

In the example illustrated in FIG. 5, on the other hand, when the short-term activity level of the conference falls below the threshold TH11, the long-term activity level of the conference falls below the threshold TH12. In other words, at this point of time, the short-term activity level and the long-term activity level of the conference are both low. In this case, the decrease in the activity level at this point of time is not temporary but is a long-term decline, and the activity level of the entire conference is estimated to be low.

In such a case, the server device 200 determines the participant having a high activity level to be the person to be spoken to in the speech operation, and prompts the participant to speak. This aims to enhance the activity level of the entire conference. In other words, a participant who has made a lot of remarks or a participant who has been enthusiastic about the discussion is made to speak, because such a speaker is more likely to lead and accelerate the discussion than a participant who has made few remarks or been not enthusiastic about the discussion. As a result, the possibility that the activity level of the entire conference will become higher is increased.

As described above, the server device 200 can select an appropriate participant on the basis of the short-term activity level and the long-term activity level of the conference, to control the speech operation being performed by the robot 100 so that the participant is prompted to speak. As a result, the discussion can be kept from coming to a halt, and be switched to a useful discussion.

Note that the threshold TH11 is preferably lower than the threshold TH12 as in the examples illustrated in FIGS. 4 and 5. This is because, while the threshold TH12 is the value for evaluating the activity level of the entire conference, the threshold TH11 is the value for determining whether to prompt a participant to speak. In a case where the activity level of the conference sharply drops due to an interruption of a speech of a participant or the like, it is preferable to prompt the participant to speak.

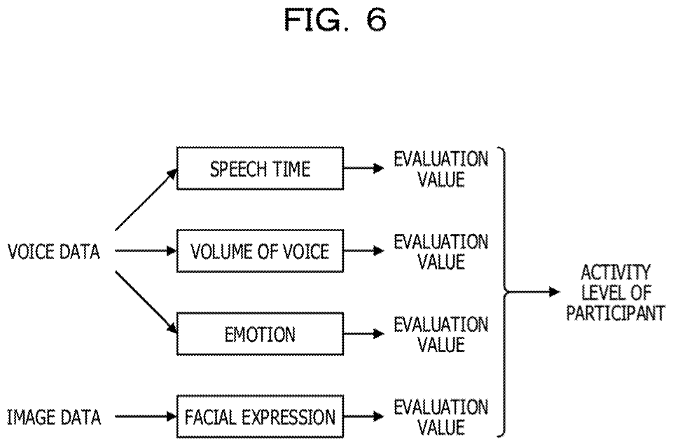

Meanwhile, the server device 200 estimates the activity level of each participant, on the basis of image data obtained by capturing an image of the respective participants and voice data obtained by collecting voices emitted by the respective participants. The server device 200 can then calculate the activity level of the conference (the short-term activity level and the long-term activity level described above) on the basis of the estimated activity levels of the respective participants, and determine the timing for the robot 100 to perform the speech operation and the person to be spoken to. Referring now to FIG. 6, a method of calculating the activity level of each participant is described.

FIG. 6 is a diagram for explaining a method of calculating the activity level of each participant. The server device 200 can calculate the activity level of each participant by obtaining evaluation values as illustrated in FIG. 6, on the basis of image data and voice data.

For example, the evaluation values to be used for calculating the activity levels of the participants may be evaluation values indicating the speech amounts of the participants. It is possible to obtain the speech amount of a participant by measuring the speech time of the participant on the basis of voice data. The longer the speech time of the participant, the higher the evaluation value. Further, other evaluation values may be evaluation values indicating the volumes of voices of the participants. It is possible to obtain the volume of a voice of participant by measuring the participant's voice level on the basis of voice data. The higher the voice level, the higher the evaluation value.

Further, it is possible to estimate the emotion of a participant on the basis of voice data, using a vocal emotion analysis technique. The estimated value of the emotion can also be used as an evaluation value. For example, the frequency components of voice data are analyzed, so that the speaking speed, the tone of the voice, the pitch of the voice, and the like can be measured as indices indicating an emotion. When the voice, the mood, and the spirit are estimated to be higher and brighter on the basis of the results of such measurement, the evaluation value is higher.

Meanwhile, from image data, the facial expression of a participant can be estimated by an image analysis technique, for example, and the estimated value of the facial expression can be used as an evaluation value. For example, when the facial expression is estimated to be closer to a smile, the evaluation value is higher.

Note that these evaluation values of the respective participants may be calculated as difference values between evaluation values measured beforehand at ordinary times and evaluation values measured during the conference, for example. Further, an evaluation value of a certain participant who has made a speech may be calculated in accordance with changes in the activity levels and the evaluation values of the other participants upon hearing (or after) the speech of the certain participant. For example, the server device 200 can calculate evaluation values in such a manner that the evaluation values of the certain participant who has made a speech become higher, when detection results show that the speeches of the other participants become more active or the facial expressions of the other participants become closer to smiles upon hearing the speech of the certain participant.

The server device 200 calculates the activity level of a participant, using one or more evaluation values among such evaluation values. In this embodiment, an evaluation value is calculated in each unit time of a predetermined length, and the activity level of a participant during the unit time is calculated on the basis of the evaluation value, for example. Further, on the basis of the activity levels calculated for the respective unit times, the short-term activity level and the long-term activity level of the participant based on a certain time are calculated.

The activity level D1 of a participant during a unit time is calculated on the basis of the evaluation values of the respective evaluation items and the correction coefficients for the respective evaluation items during the unit time, according to Expression (1) shown below. Note that the correction coefficients can be set as appropriate, depending on the type, the agenda, the purpose, and the like of the conference. D1=Σ(evaluation value x correction coefficient) . . . (1)

The short-term activity level D2 of the participant is calculated as the total value of the activity levels D1 during the period of the length of (unit time×n) ending at the current time (where n is an integer of 1 or greater). Further, the long-term activity level D3 of the participant is calculated as the total value of the activity levels D1 during the period of the length of (unit time x m) ending at the current time (where m is a greater integer than n).

The short-term activity level D4 and long-term activity level D5 of the conference are calculated from the short-term activity levels D2 and the long-term activity levels D3 of the respective participants and the number P of the participants, according to Expressions (2) and (3) shown below.

D4=Σ(D2)/P (2)

D5=Σ(D3)/P (3)

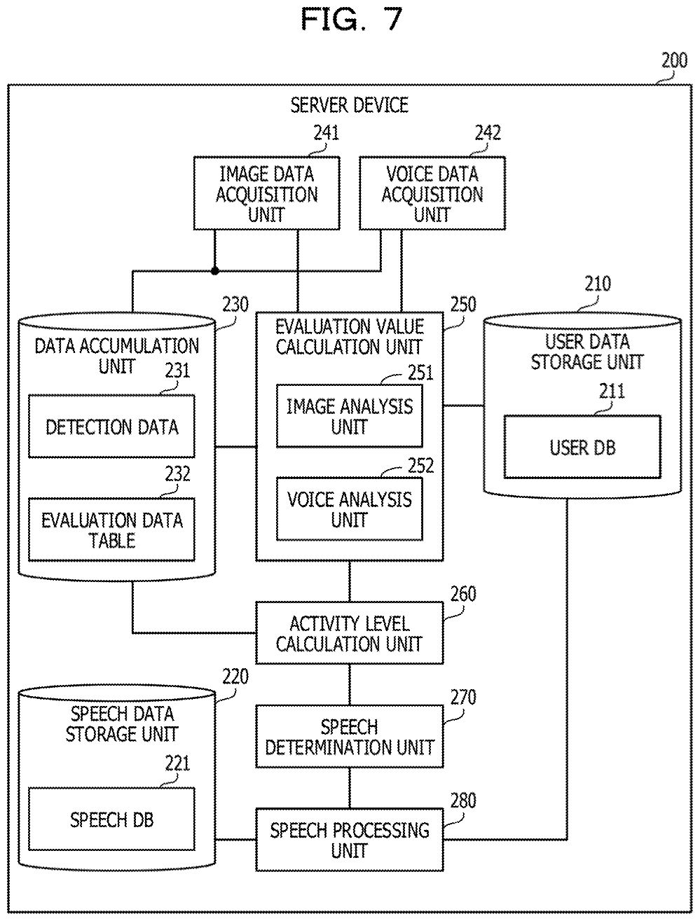

FIG. 7 is a block diagram illustrating an example configuration of the processing functions of the server device.

The server device 200 includes a user data storage unit 210, a speech data storage unit 220, and a data accumulation unit 230. The user data storage unit 210 and the speech data storage unit 220 are formed as storage areas of a nonvolatile storage included in the server device 200, such as the HDD 203, for example. The data accumulation unit 230 is formed as a storage area of a volatile storage included in the server device 200, such as the RAM 202, for example.

The user data storage unit 210 stores a user database (DB) 211. In the user database 211, various kinds of data for each user who can be a participant in the conference are registered in advance. For each user, the user database 211 stores a user ID, a user name, face image data for identifying the user's face through image analysis, and voice pattern data for identifying the user's voice through voice analysis, for example.

The speech data storage unit 220 stores a speech database (DB) 221. The speech database 221 stores the voice data to be used when the robot 100 speaks.

The data accumulation unit 230 stores detection data 231 and an evaluation value table 232. The detection data 231 includes image data and voice data acquired from the robot 100. Evaluation values calculated for the respective participants in the conference on the basis of the detection data 231 are registered in the evaluation value table 232.

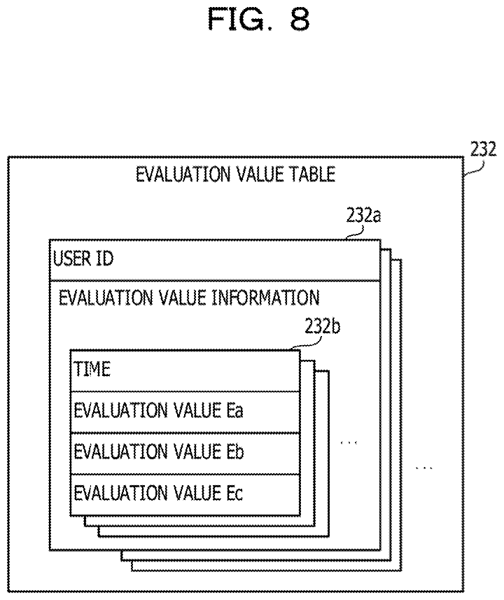

FIG. 8 is a diagram illustrating an example data structure of the evaluation value table, As illustrated in FIG. 8, records 232a of the respective users who can be participants in the conference are registered in the evaluation value table 232. A user ID and evaluation value information including evaluation values of the user are registered in the record 232a of each user.

Records 232b for the respective unit times are registered in the evaluation value information. A time for identifying a unit time (a representative time such as the start time or the end time of a unit time, for example), and evaluation values calculated on the basis of image data and voice data acquired in the unit time are registered in each record 232b, In the example illustrated in FIG. 8, three kinds of evaluation values Ea through Ec are registered.

Referring back to FIG. 7, explanation of the processing functions is continued.

The server device 200 further includes an image data acquisition unit 241, a voice data acquisition unit 242, an evaluation value calculation unit 250, an activity level calculation unit 260, a speech determination unit 270, and a speech processing unit 280. The processes to be performed by these respective units are realized by the processor 201 executing a predetermined application program, for example.

The image data acquisition unit 241 acquires image data that has been obtained through imaging performed by the camera 101 of the robot 100 and been transmitted from the robot 100 to the server device 200, and stores the image data as the detection data 231 into the data accumulation unit 230.

The voice data acquisition unit 242 acquires voice data that has been obtained through sound collection performed by the microphone 102 of the robot 100 and been transmitted from the robot 100 to the server device 200, and stores the voice data as the detection data 231 into the data accumulation unit 230.

The evaluation value calculation unit 250 calculates the evaluation values of each participant in the conference, on the basis of the image data and the voice data included in the detection data 231. As described above, these evaluation values are the values to be used for calculating the activity level of each participant and the activity level of the conference. To calculate the evaluation values, the evaluation value calculation unit 250 includes an image analysis unit 251 and a voice analysis unit 252.

The image analysis unit 251 reads image data from the detection data 231, and analyzes the image data. The image analysis unit 251 identifies the user seen in the image as a participant in the conference, on the basis of the face image data of each user stored in the user database 211, for example. The image analysis unit 251 then calculates an evaluation value of each participant by analyzing the image data, and registers the evaluation value in each corresponding user's record 232a in the evaluation value table 232. For example, the image analysis unit 251 recognizes the facial expression of each participant by analyzing the image data, and calculates the evaluation value of the facial expression.

The voice analysis unit 252 reads voice data from the detection data 231, calculates an evaluation value of each participant by analyzing the voice data, and registers the evaluation value in each corresponding user's record 232a in the evaluation value table 232. For example, the voice analysis unit 252 identifies a speaking participant on the basis of the voice pattern data about the respective participants in the conference stored in the user database 211, and also identifies the speech zone of the identified participant. The voice analysis unit 252 then calculates the evaluation value of the participant during the speech time, on the basis of the identification result. The voice analysis unit 252 also performs vocal emotion analysis, to calculate evaluation values of emotions of the participants on the basis of voices.

The activity level calculation unit 260 calculates the short-term activity levels and the long-term activity levels of the participants, on the basis of the evaluation values of the respective participants registered in the evaluation value table 232. The activity level calculation unit 260 also calculates the short-term activity level and the long-term activity level of the conference, on the basis of the short-term activity levels and the long-term activity levels of the respective participants.

The speech determination unit 270 determines whether to cause the robot 100 to perform a speech operation to prompt a participant to speak, on the basis of the results of the activity level calculation performed by the activity level calculation unit 260. In a case where the robot 100 is to be made to perform a speech operation, the speech determination unit 270 determines which participant is to be prompted to speak.

The speech processing unit 280 reads the voice data to be used for the speech operation from the speech database 221, on the basis of the result of the determination made by the speech determination unit 270. The speech processing unit 280 then transmits the voice data to the robot 100, to cause the robot 100 to perform the desired speech operation.

Note that at least one of the processing functions illustrated in FIG. 8 may be mounted in the robot 100. For example, the evaluation value calculation unit 250 may be mounted in the robot 100, so that the evaluation values of the respective participants can be calculated by the robot 100 and be transmitted to the server device 200. Alternatively, the processing functions of the server device 200 and the robot 100 may be integrated, and all the processes to be performed by the server device 200 may be performed by the robot 100.

Next, the processes to be performed by the server device 200 are described with reference to a flowchart.

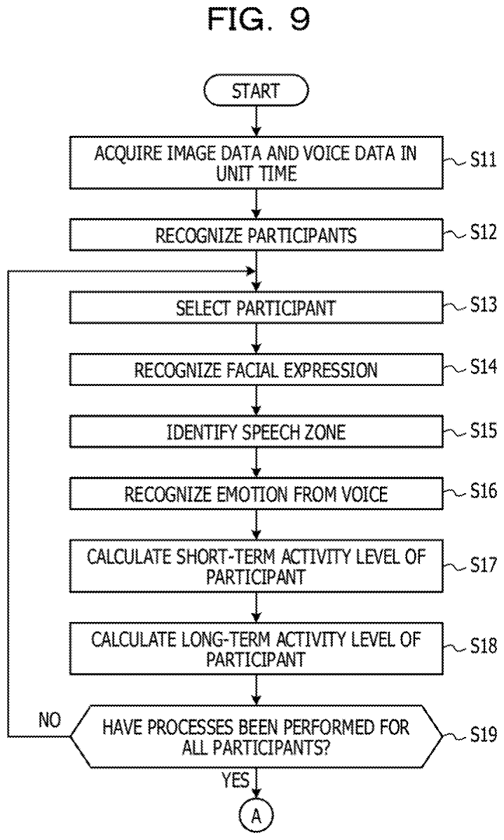

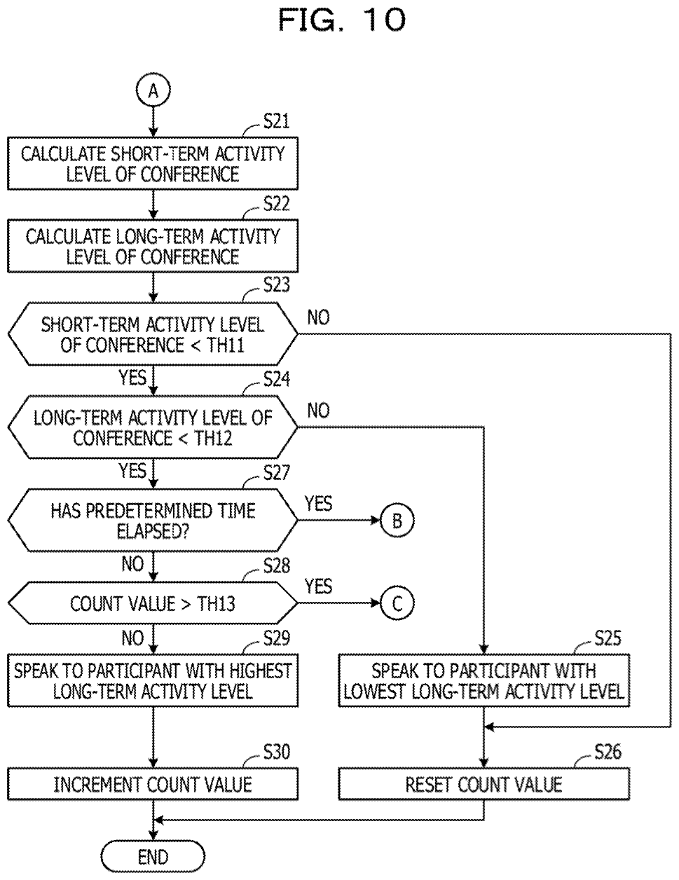

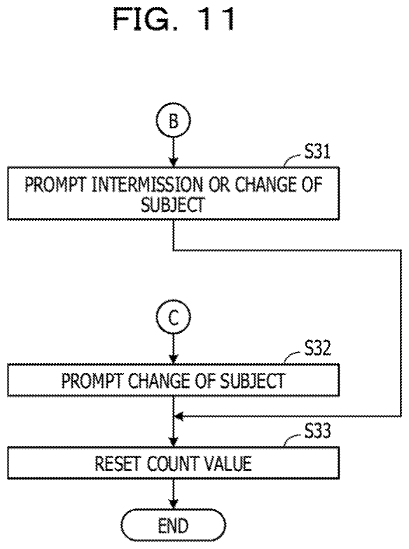

FIGS. 9 through 11 are an example of a flowchart illustrating the processes to be performed by the server device 200. The processes in FIGS. 9 through 11 are repeatedly performed in the respective unit times. Note that although not illustrated in the drawings, the RAM 202 of the server device 200 stores the count value to be referred to in the processes in FIGS. 10 and 11.

[Step S11] The image data acquisition unit 241 acquires image data that has been obtained through imaging performed by the camera 101 of the robot 100 in a unit time and been transmitted from the robot 100 to the server device 200, and stores the image data as the detection data 231 into the data accumulation unit 230. Also, the voice data acquisition unit 242 acquires voice data that has been obtained through sound collection performed by the microphone 102 of the robot 100 in a unit time and been transmitted from the robot 100 to the server device 200, and stores the voice data as the detection data 231 into the data accumulation unit 230.

[Step S12] The image analysis unit 251 of the evaluation value calculation unit 250 reads the image data acquired in step S11 from the detection data 231, and performs image analysis using the face image data about each user stored in the user database 211. By doing so, the image analysis unit 251 recognizes the participants in the conference during the unit time from the image data. Note that, as a process of recognizing the participants in the conference is performed in each unit time, each participant who has joined halfway through the conference can be recognized.

[Step S13] The evaluation value calculation unit 250 selects one of the participants recognized in step S12.

[Step S14] The image analysis unit 251 analyzes the image data of the face of the selected participant out of the image data acquired in step S11, recognizes the facial expression of the participant, and calculates the evaluation value of the facial expression. The image analysis unit 251 registers the calculated evaluation value in the record 232a corresponding to the selected participant among the records 232a in the evaluation value table 232. Note that, in a case where the record 232a corresponding to the corresponding participant does not exist in the evaluation value table 232, the image analysis unit 251 adds a new record 232a to the evaluation value table 232, and registers the user ID indicating the participant and the evaluation value in the record 232a.

[Step S15] The voice analysis unit 252 of the evaluation value calculation unit 250 reads the voice data acquired in step S11 from the detection data 231, and analyzes the voice data, using the voice pattern data of the respective participants in the conference stored in the user database 211. Through this analysis, the voice analysis unit 252 determines whether the participant selected in step S13 is speaking, and if so, identifies the speech zone. The voice analysis unit 252 calculates the evaluation value the speech time, on the basis of the result of such a process. For example, the evaluation value is calculated as the value indicating the proportion of the speech time of the participant in the unit time. Alternatively, the evaluation value may be calculated as the value indicating whether the participant has spoken during the unit time. The voice analysis unit 252 registers the calculated evaluation value in the record 232a corresponding to the selected participant among the records 232a in the evaluation value table 232.

[Step S16] The voice analysis unit 252 recognizes the emotion of the participant by performing vocal emotion analysis using the voice data read in step S15, and calculates an evaluation value indicating the emotion. The voice analysis unit 252 registers the calculated evaluation value in the record 232a corresponding to the selected participant among the records 232a in the evaluation value table 232.

As described above, in the example illustrated in FIG. 9, three kinds of evaluation values calculated in steps S14 through S16 are used for calculating an activity level. However, this is merely an example. Any evaluation value other than the above may be calculated from image data and voice data, or only one of these evaluation values may be calculated.

[Step S17] The activity level calculation unit 260 reads the evaluation values corresponding to the latest n unit times from the record 232a corresponding to the participant in the evaluation value table 232. The activity level calculation unit 260 classifies the read evaluation values into the respective unit times, and calculates the activity level D1 of the participant in each unit time, according to Expression (1) described above. The activity level calculation unit 260 adds up the calculated activity levels D1 of all the n unit times, to calculate the short-term activity level D2 of the participant.

[Step S18] The activity level calculation unit 260 reads the evaluation values corresponding to the latest m unit times from the record 232a corresponding to the participant in the evaluation value table 232. Here, between m and n, there is a relationship expressed as m>n. The activity level calculation unit 260 classifies the read evaluation values into the respective unit times, and calculates the activity level 01 of the participant in each unit time, according to Expression (1). The activity level calculation unit 260 adds up the calculated activity levels D1 of all the m unit times, to calculate the long-term activity level 03 of the participant.

[Step S19] The activity level calculation unit 260 determines whether the processes in steps S13 through S18 have been performed for all participants recognized in step S12. If there is at least one participant for whom the processes have not been performed yet, the activity level calculation unit 260 returns to step S13. As a result, one of the participants for whom the processes have not been performed is selected, and the processes in steps S13 through 518 are performed. If the processes have been performed for all the participants, on the other hand, the activity level calculation unit 260 moves to step S21 in FIG. 10.

In the description below,the explanation is continued with reference to FIG. 10.

[Step S21] On the basis of the short-term activity level D2 of each participant calculated in step S17, the activity level calculation unit 260 calculates the short-term activity level 04 of the conference, according to Expression (2) described above.

[Step S22] On the basis of the long-term activity level D3 of each participant calculated in step S18, the activity level calculation unit 260 calculates the long-term activity level D5 of the conference, according to Expression (3) described above

[Step S23] The speech determination unit 270 determines whether the short-term activity level D4 of the conference calculated in step S21 is lower than the predetermined threshold TH11. If the short-term activity level D4 is lower than the threshold TH11, the speech determination unit 270 moves on to step S24. If the short-term activity level D4 is equal to or higher than the threshold TH11, the speech determination unit 270 moves on to step S26.

[Step S24] The speech determination unit 270 determines whether the long-term activity level D5 of the conference calculated in step S22 is lower than the predetermined threshold TH12. If the long-term activity level D5 is lower than the threshold TH12, the speech determination unit 270 moves on to step S27. If the long-term activity level DS is equal to or higher than the threshold TH12, the speech determination unit 270 moves on to step S25.

[Step S25] On the basis of the long-term activity level D3 of each participant calculated in step S18, the speech determination unit 270 determines that the participant having the lowest long-term activity level D3 among the participants is the person to be spoken to. The speech determination unit 270 notifies the speech processing unit 280 of the user ID indicating the person to be spoken to, and instructs the speech processing unit 280 to perform a speech operation to prompt the person to be spoken to to speak.

The speech processing unit 280 that has received the instruction refers to the user database 211, to recognize the name of the person to be spoken to. The speech processing unit 280 then synthesizes voice data for calling the name. The speech processing unit 280 also reads the voice pattern data for prompting a speech from the speech database 221, and combines the voice pattern data with the voice data of the name, to generate the voice data to be output in the speech operation. The speech processing unit 280 transmits the generated voice data to the robot 100, and requests the robot 100 to perform the speech operation. As a result, the robot 100 outputs a voice based on the transmitted voice data from the speaker 103, and speaks to the participant with the lowest long-term activity level 03, to prompt the participant to speak.

[Step S26] The speech determination unit 270 resets the count value stored in the RAM 202 to 0. Note that this count value is the value indicating the number of times the later described step S29 has been carried out.

[Step S27] The speech determination unit 270 determines whether a predetermined time has elapsed since the start of the conference. If the predetermined time has not elapsed, the speech determination unit 270 moves on to step S28. If the predetermined time has elapsed, the speech determination unit 270 moves on to step S31 in FIG. 11. Note that the predetermined time is a time sufficiently longer than the long-term activity level calculation period.

[Step S28] The speech determination unit 270 determines whether the count value stored in the RAM 202 is greater than a predetermined threshold TH13. Note that the threshold TH13 is set beforehand at an integer of 2 or greater. If the count value is equal to or smaller than the threshold TH13, the speech determination unit 270 moves on to step S29. If the count value is greater than the threshold TH13, the speech determination unit 270 moves on to step S32 in FIG. 11.

[Step S29] On the basis of the long-term activity level 03 of each participant calculated in step S18, the speech determination unit 270 determines that the participant having the highest long-term activity level 03 among the participants is the person to be spoken to. The speech determination unit 270 notifies the speech processing unit 280 of the user ID indicating the person to be spoken to, and instructs the speech processing unit 280 to perform a speech operation to prompt the person to be spoken to to speak.

The speech processing unit 280 that has received the instruction refers to the user database 211, to recognize the name of the person to be spoken to. The speech processing unit 280 then generates the voice data to be output in the speech operation, through the same procedures as in step S25. The speech processing unit 280 transmits the generated voice data to the robot 100, and requests the robot 100 to perform the speech operation. As a result, the robot 100 outputs a voice based on the transmitted voice data from the speaker 103, and speaks to the participant with the highest long-term activity level D3, to prompt the participant to speak.

[Step S30] The speech determination unit 270 increments the count value stored in the RAM 202 by 1.

In the description below, the explanation is continued with reference to FIG. 11.

[Step S31] The speech determination unit 270 instructs the speech processing unit 280 to perform a speech operation to prompt the participants in the conference to take a break. The speech determination unit 270 reads from the speech database 221 the voice data for prompting a break, transmits the voice data to the robot 100, and requests the robot 100 to perform the speech operation. As a result, the robot 100 outputs a voice based on the transmitted voice data from the speaker 103, and speaks to prompt a break. Note that, in this step S31, a speech operation for prompting a change of subject may be performed.

[Step S32] The speech determination unit 270 instructs the speech processing unit 280 to perform the speech operation to prompt the participants the conference to change the subject. The speech determination unit 270 reads from the speech database 221 the voice data for prompting a change of subject, transmits the voice data to the robot 100, and requests the robot 100 to perform the speech operation. As a result, the robot 100 outputs a voice based on the transmitted voice data from the speaker 103, and speaks to prompt a change of subject.

Note that the contents of the speech for prompting a change of subject may be contents that are prepared in advance and have no relation to the contents of the conference, for example. For example, even when a person makes a remark that is unrelated to the contents of the conference and is out of place, the robot 100 might be able to relax the atmosphere and change the mood of the listeners.

[Step S33] The speech determination unit 270 resets the count value stored in the RAM 202 to 0.

In the processes illustrated in FIGS. 9 through 11 described above, in a case where the short-term activity level of the conference is lower than the threshold TH11, and the long-term activity level of the conference is equal to or higher than the threshold TH12, a speech operation is performed in step S25, to prompt the participant having the lowest long-term activity level to speak. Thus, the activity levels among the participants are made uniform, and the quality of discussions can be increased.

Further, in a case where the short-term activity level of the conference is lower than the threshold TH11, and the long-term activity level of the conference is lower than the threshold TH12, a speech operation is performed in step S29, to prompt the participant having the highest long-term activity level to speak. Thus, discussions can be activated.

However, even in a case where the current time is determined to be the timing to prompt the participant having the highest long-term activity level to speak, if the determination result is Yes in step S27, there is a possibility that a certain amount of time has elapsed since the start of the conference, and the discussion has come to a halt. In such a case, a speech operation is performed in step S31, to prompt a break or a change of subject. This increases the possibility of activation of discussions.

Also, even in a case where the current time is determined to be the timing to prompt the participant having the highest long-term activity level to speak, if the determination result is Yes in step S28, it can be considered that the activity level of the conference has not risen, though the speech operation in step S29 has been performed many times to activate discussions. In such a case, a speech operation is performed in step S32, to prompt a change of subject. This increases the possibility that the activity level of the conference will rise.

As described above, through the processes in the server device 200, the robot 100 can be made to perform a speech operation suitable for enhancing the activity level of the conference at an appropriate timing, in accordance with the results of conference state determination based on the transition of the activity level of the conference. Thus, the activity level of the conference can be maintained at a certain level, and useful discussions can be made, without being affected by the skill of the moderator of the conference.

Furthermore, in achieving the above effects, there is no need to perform a complicated, high-load operation, such as analysis of the contents of speeches made by the participants.

Note that the processing functions of the devices (the control device 20 and the server device 200, for example) described the above respective embodiments can be realized with a computer. In that case, a program describing the process contents of the functions each device is to have is provided, and the above processing functions are realized in the computer executing the program. The program describing the process contents can be recorded on a computer-readable recording medium. The computer-readable recording medium may be a magnetic storage device, an optical disk, a magneto-optical recording medium, a semiconductor memory, or the like. A magnetic storage device may be a hard disk drive (HDD), a magnetic tape, or the like. An optical disk may be a compact disc (CD), a digital versatile disc (DVD), a Blu-ray disc (BD, registered trademark), or the like. A magneto-optical recording medium may be a magneto-optical (MO) disk or the like.

In a case where a program is to be distributed, portable recording media such as DVDs and CDs, in which the program is recorded, are sold, for example. Alternatively, it is possible to store the program in a storage of a server computer, and transfer the program from the server computer to another computer via a network.

The computer that executes the program stores the program recorded on a portable recording medium or the program transferred from the server computer in its own storage, for example. The computer then reads the program from its own storage, and performs processes according to the program. Note that the computer can also read the program directly from a portable recording medium, and perform processes according to the program. Further, the computer can also perform processes according to the received program, every time the program is transferred from a server computer connected to the computer via a network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
calculating an activity level for each of a plurality of participants in a conference;
determining whether to cause a voice output device to perform a speech operation to speak to one of the participants, based on a first activity level of the entire conference during a first period until a time that is earlier than a current time by a first time, the first activity level being calculated based on the respective activity levels of the plurality of participants; and
when having determined to cause the voice output device to perform the speech operation, determining a person to be spoken to in the speech operation from among the participants, based on a second activity level of the entire conference during a second period until a time that is earlier than the current time by a second time longer than the first time, and the respective activity levels of the participants, the second activity level being calculated based on the respective activity levels of the participants.

2. The non-transitory computer-readable storage medium according to claim wherein
the determining process includes:
when the second activity level is lower than a first threshold, determining the participant having the highest activity level among the participants as the person to be spoken to in the speech operation, and
when the second activity level is not lower than the first threshold, determining the participant having the lowest activity level among the participants as the person to be spoken to in the speech operation.

3. The non-transitory computer-readable storage medium according to claim , wherein
when the first activity level is lower than a predetermined second threshold, the determining process includes determining whether to cause the voice output device to perform the speech operation,

4. The non-transitory computer-readable storage medium according to claim 2, wherein
the process further comprises:
counting the number of times the speech operation has been performed, with the person to be spoken to being the participant having the highest activity level among the participants, and
when the second activity level is lower than the first threshold, and the number of times exceeds a third threshold, the voice output device is made to output a voice indicating predetermined speech contents.

5. The non-transitory computer-readable storage medium according to claim 2, wherein
when the second activity level is lower than the first threshold, and a certain time has elapsed since execution of the speech operation in the past, the voice output device is made to output a voice indicating predetermined speech contents.

6. The non-transitorycomputer-readable storage medium according to claim 1, wherein
the speech operation is an operation for outputting a voice that prompts the person to be spoken to speak.

7. The non-transitory computer-readable storage medium according to claim 1 wherein
the calculating process includes the activity level of each of the participants is calculated, based on a result of detection of a speech situation of each of the participants in the conference,

8. A speaker direction determination device comprising:
a memory; and
a processor coupled to the memory and the processor configured to:
calculate an activity level for each of a plurality of participants in a conference;
determine whether to cause a voice output device to perform a speech operation to speak to one of the participants, based on a first activity level of the entire conference during a first period until a time that is earlier than a current time by a first time, the first activity level being calculated based on the respective activity levels of the participants; and
when having determined to cause the voice output device to perform the speech operation, determine a person to be spoken to in the speech operation from among the participants, based on a second activity level of the entire conference during a second period until a time that is earlier than the current time by a second time longer than the first time, and the respective activity levels of the participants, the second activity level being calculated based on the respective activity levels of the participants.

9. A controlmethod executed by a computer, the control method comprising:
calculating an activity level for each of a plurality of participantsin a conference;
determining whether to cause a voice output device to perform a speech operation to speak to one of the participants, based on a first activity level of the entire conference during a first period until a time that is earlier than a current time by a first time, the first activity level being calculated based on the respective activity levels of the participants; and
when having determined to cause the voice output device to perform the speech operation, determining a person to be spoken to in the speech operation from among the participants, based on a second activity level of the entire conference during a second period until a time that is earlier than the current time by a second time longer than the first time, and the respective activity levels of the participants, the second activity level being calculated based on the respective activity levels of the participants.
